(19) United States
(12) Patent Application Publication
(10) Pub. No.: US 2026/0001721 A1
(43) Pub. Date: Jan. 1, 2026

(54) Feederhouse Belt Coupling Arrangement

(71) Applicant: AGCO do Brasil Soluções Agrícolas Ltda., Jundiaí (BR)

(72) Inventor: Airton Solimar Walter, Canoas (BR)

(21) Appl. No.: 19/251,310

(22) Filed: Jun. 26, 2025

(30) Foreign Application Priority Data
Jun. 27, 2024 (GB) 2409310.6

(51) Int. Cl. B65G 15/30; A01D 61/00

(52) U.S. Cl. CPC B65G 15/30; A01D 61/008

(57) ABSTRACT

A feederhouse belt and coupling arrangement has an elongate belt with an elongate web with a first free end and a second free end. A coupler has a connecting element with first and second hinge elements, each hinge element having an interconnecting portion for interleaving with an adjacent hinge element and an outer portion having a free end and a securing element adapted to secure the hinge elements to one another. First and second coupling elements each have an upper element and a lower element, an outer edge of each upper element and an outer edge of each lower element having flanges adapted to received and retain a respective free end of the elongate belt therebetween. An inner edge of each upper element and an inner edge of each lower element have flanges adapted to received and retain the free end of the outer connecting portion of the connection element.

### CROSS-REFERENCE TO RELATED APPLICATIONS

This application claims the benefit of the filing date of U. K. Patent Application 2409310.6, “Feederhouse Belt Coupling Arrangement,” filed Jun. 27, 2024, the entire disclosure of which is incorporated herein by reference.

### FIELD

Embodiments of the present disclosure relate generally to combine harvesters, and in particular to the feederhouse used to deliver crop material to the threshing system of the combine harvester, and more particularly to the belt arrangement within the feederhouse.

### BACKGROUND

A combine harvester typically includes a crop cutting head and a threshing system for detaching grains of cereal from the ears of cereal. A delivery system delivers the cut crop to the threshing system, known as the feederhouse. A separating apparatus is downstream of the threshing system, and a grain cleaning apparatus receives grain from the separating apparatus. A stratification pan aims to stratify the material into a layered structure of grain at the bottom and light chaff and other material other than grain (MOG) at the top.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit.

The feederhouse is one of the limiting performance factors of modern large combines and there is therefore a continuing need for an improved feederhouse design.

The feederhouse is typically in the form of a set of conveyor chains or belts with cross bars or slats extending between pairs of chains or belts that transport the crop material within the feederhouse.

Belt arrangements are preferred to chain arrangements for the conveyor due to the noise generated by chain conveyors and the wear caused to the chain links during operation. The belts are typically formed of fibre reinforced elastomeric webbing. However, such belts are not without their own problems. It is necessary to provide couplings to secure the ends of the webbing together while accommodating the sprockets as the they drive the belts.

Additionally, through use, such belts become worn over time and so lose tension. When a belt no longer provides useful drive, farmers typically replace the entire set of feederhouse belts. The present invention aims to provide an alternative coupling arrangement that allows for adjustment in the belt tension.

It is an advantage of the present invention that it allows for restoration of tension in a worn feederhouse belt and coupling arrangement.

### BRIEF SUMMARY

According to a first aspect of the present invention, a feederhouse belt and coupling arrangement for a feederhouse feed conveyor of an agricultural harvester is disclosed, the arrangement comprising:
an elongate belt comprising an elongate web with a first free end and a second free end, wherein the first end and the second end are thicker than the elongate web; and
a coupler having:
a connecting element, wherein the connecting element comprises first and second hinge elements, each hinge element having an interconnecting portion for interleaving with an adjacent hinge element and an outer portion having a free end and a securing element adapted to secure the first and second hinge elements with respect to one another;
first and second coupling elements, each coupling element comprising an upper element and a lower element, an outer edge of each upper element and an outer edge of each lower element having flanges adapted to received and retain a respective free end of the elongate belt therebetween, an inner edge of each upper element and an inner edge of each lower element having flanges adapted to received and retain the free end of the outer connecting portion of the connection element;
at least one fastener adapted to draw the first and second coupling elements together.

Preferably, the first and second hinge elements are provided with grooves on a first surface adapted to receive the flanges of the first and second lower coupling elements.

Preferably, the first and second hinge elements are provided with grooves on a second surface adapted to receive the flanges of the first and second upper coupling elements.

Preferably, the securing element comprises a threaded locking pin.

Preferably, for each fastener adapted to draw the first and second coupling elements together, the outer portion of the respective hinge element is provided with an opening through which the fastener adapted to draw the first and second coupling elements together extends.

More preferably, each opening is part circular in section, with a diameter extending parallel to a central axis of the connecting element being set back from an outer edge of the outer portion of the hinge elements though which it extends.

According to a second aspect of the invention, a feederhouse belt comprises a plurality of feederhouse belts, including at least one belt and coupling arrangement according to the first aspect of the present invention, and a drive arrangement for the feederhouse belts and a plurality of slats fixed to and between adjacent feederhouse belts, each of the slats extending laterally between a pair of feederhouse belts.

According to a third aspect of the present invention, a combine harvester comprises a crop cutting head; a feederhouse according to the second aspect of the invention; a threshing system; a separating system; and a grain cleaning system for receiving the cut and threshed crop material.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a schematic side view of a known combine harvester comprising a residue spreader positioned after or downstream of a straw chopper;

FIG. 2 shows a perspective view of elements of a feederhouse belt arrangement;

FIG. 3 shows a perspective view of elements of a known belt coupling;

FIG. 4 shows a schematic perspective view of a first embodiment of a feederhouse belt coupling arrangement apparatus for such a feederhouse belt drive;

FIG. 5 shows a first perspective view of the feederhouse belt coupling arrangement of FIG. 4 with the belts omitted;

FIG. 6 shows a second perspective view of the feederhouse belt coupling arrangement of FIG. 5;

FIG. 7 shows a sectional view of the feederhouse belt coupling arrangement shown in FIG. 5;

FIG. 8 shows a perspective view of the connecting element and parts of one coupling element forming part of the coupling arrangement shown in FIGS. 4 to 7; and

FIG. 9 shows a view similar to that of FIG. 8 showing elements of a second embodiment of a feederhouse belt coupling arrangement apparatus.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

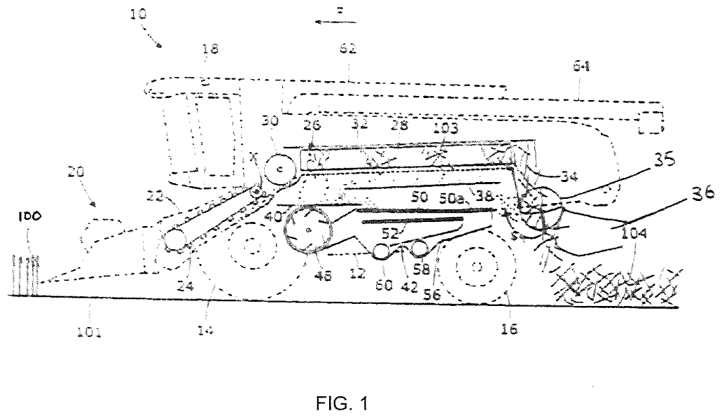

Relative terms such as forward, rearward, transverse, lateral, longitudinal and sideways will be made with reference to the normal forward direction of travel of the combine 10 and indicated by arrow F represented in FIG. 1. The terms vertical and horizontal will be made with reference to the level ground 101 upon which the combine 10 is disposed. In other words the Cartesian axes of ‘longitudinal’, ‘transverse’, and ‘vertical’ are made in relation to the chassis 12 of combine 10 and are not affected by any slope in the ground. The terms “upstream” and “downstream” are made with reference to the general direction of crop flow along the material conveyance systems described.

FIG. 1 illustrates in schematic form the main components of the crop processing system of a combine harvester 10 and will be used to explain the flow of material below. The crop processing system is shown in solid lines whilst the outline profile of harvester 10 is shown in ghost form.

Combine harvester 10, hereinafter referred to as ‘combine’, includes a chassis 12 supported on front wheels 14 and rear steerable wheels 16 which engage the ground 101. A driver's cab 18 is also supported on the chassis 12 and houses a driver's station from where a driver controls the combine 10.

A cutting header 20 is detachably supported on the front of a feeder house 22 which is pivotable about a transverse axis x to lift and lower the header 20 in a conventional manner.

The combine 10 is driven in a forward direction (arrow F) across a field of standing crop 100 in a known manner. The header 20 serves to cut and gather the standing crop material before conveying such as a crop material stream into feeder house 22. An elevator 24, normally in the form of a chain and slat conveyor or elevator as shown, is housed within the feeder house 22 and serves to convey the crop material stream upwardly and rearwardly from the header 20 to the crop processor designated generally at 26. At this stage the crop material stream is unprocessed.

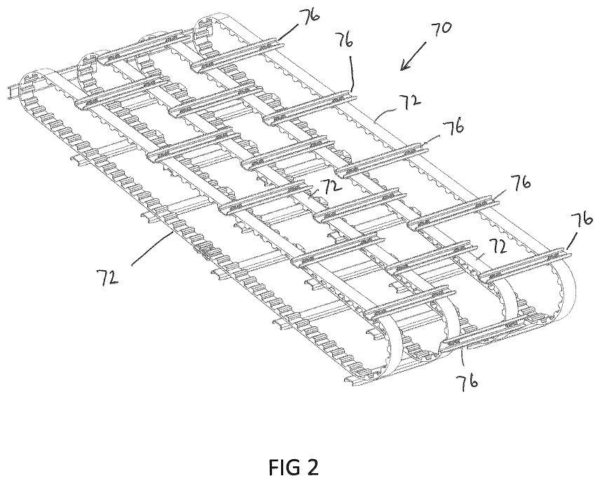

FIG. 2 shows an example belt arrangement 70 for the conveyor. The conveyor typically comprises a laterally extending front shaft extending through the sidewalls of the housing at the front of the feederhouse where it couples to the agricultural harvesting head and a laterally extending rear shaft that extends through the sidewalls of the housing at the rear of the housing where it couples to the combine. In the illustrated example, four endless belts 72 extend around these two shafts, typically on toothed sprockets. The inner side of each endless belt 72 is provided with recesses 74 into which drive pins of the sprockets become seated to drive the belts.

Slats 76 are fixed to and between the belts 72 and extend laterally, generally parallel to the two shafts. It is also known to use three endless belts extending around the front and rear shafts to support the slats.

The crop processor 26 of the illustrated combine 10 includes a pair of axial flow threshing and separating rotors 28 fed by a tangential flow, crop material impelling, feed beater 30. It should be appreciated however that alternative types of crop processor may be used without deviating from the scope of the invention. For example, the crop processor may instead include a conventional tangential flow threshing cylinder with a plurality of straw walkers for separation. Alternatively, a single axial-flow processing rotor may be employed.

Turning back to FIG. 1, the feed beater 30 rotates on a transverse axis and comprises crop engaging deflectors (not shown) which convey the crop material stream under the beater and into rotor housings 32 which each house one of said rotors 28. It should be appreciated that only the left-hand rotor 28 and housing 32 is shown in FIG. 1 whereas the right-hand equivalent is hidden from view.

The rotors 28 are positioned to have a generally longitudinal, or fore and aft, rotation axis which is normally inclined upwardly towards the rear of the combine 10.

Flighting elements (not shown) provided on the front end of each rotor 28 engage the crop material stream which is then conveyed as a ribbon or mat 103 in a generally rearward axial and helical path in the space between the rotor 28 and the rotor housing 32.

The axial flow rotors 28 serve to thresh the crop stream in a front region, separate the grain therefrom in a rear region, and eject the straw residue via a straw discharge chute 34 provided below a rear portion of the rotors 28, the straw falling either directly onto the ground in a windrow, or via a straw chopper 35 and straw spreader 36 to be described in more detail later.

A part-cylindrical grate or concave 37 provided in the underside of each rotor housing 32 allows the separated material to fall by gravity onto either a return pan 38 located below a rear section of the processor 26, or directly onto a stratification pan 40 located below a front section of the processor 26. In reality, the separated material falling through the grate 37 is typically a mix of grain and material other than grain (MOG) which may include chaff, tailings and some straw.

The return pan 38 and stratification pan 40 together serve as a material conveyance system arranged to convey the separated crop material to a grain cleaning shoe designated generally at 42. The pans 38,40 each include a respective linkage (not shown) to convert a torque source into oscillating motion to oscillate the pans in a generally fore and aft direction. Combined with a transversely rippled or corrugated floor, the oscillating movement of the return pan 38 and stratification pan 40 propels the material generally forwardly or rearwardly respectively.

The return pan 38 “returns” the separated material incident thereon towards the front of the combine 10 (in the direction F) to a front discharge edge 44 from where the material falls or cascades onto the stratification pan 40. The material on the stratification pan 40 is conveyed rearwardly to a rear discharge edge 46 from where the material falls into the cleaning system or “shoe” 42.

The grain-MOG mix falls from the rear discharge edge 46 into the cleaning shoe 42 where the cascading mix is subjected to a cleaning airstream generated by fan 48, before falling onto the front of upper sieve or chaffer 50.

Chaffer 50 comprises adjustable louvres supported on a frame which is driven in fore-and-aft oscillating manner. The material which settles on the chaffer 50 is conveyed in a generally rearward direction and the heavier smaller grain-rich material passes between the louvres onto an underlying lower sieve 52, whereas the lighter larger material (mostly chaff) passes to the end of the chaffer and out of the rear of the machine at shoe outlet 54. A rear section of chaffer 50a is commonly independently adjustable and is configurable to allow tailings to pass there through into a re-threshing region 56 from where the tailings are conveyed via a re-threshing auger 58 back to the processor 26.

Lower sieve 52 is also driven in an oscillating manner to convey the collected grain-MOG mix rearwardly wherein the material falling there through is collected by a clean grain auger 60 for conveyance to an elevator (not shown) for onward conveyance to a grain tank 62. Material which does not pass through lower sieve 52 and is instead conveyed off the rear edge thereof falls into re-threshing region 56 for subsequent re-threshing.

The airstream generated by fan unit 48 is also conveyed by ducting up through lower sieve 52 and chaffer 50 to encourage lifting of the MOG from the chaffer surface.

For completeness the combine 10 includes an unloading system which includes an unloading auger 64.

Aspects of the invention relate to the design of a coupling arrangement for the belt drive for a feederhouse of a combine harvester.

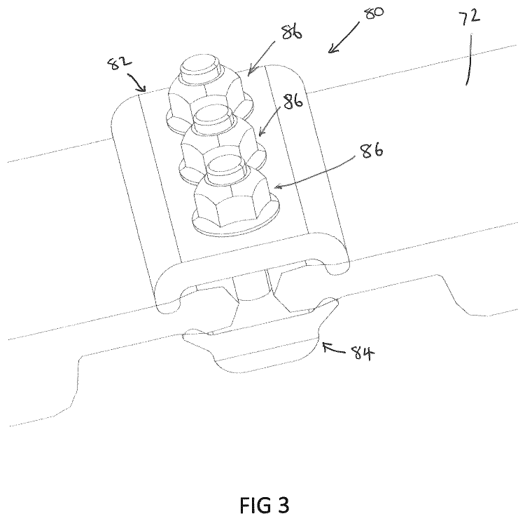

A known belt coupling is shown in FIG. 3. The belt 72 typically comprises a strip or web of fabric material, such as a polymer fabric. Such webs are typically moulded to provide lands 76 and recesses 74 on one side, in use to form an inner surface of an endless belt. The ends of the web are enlarged and a reinforcement such as a metal rod, incorporated in the moulding at each end. The ends of the web are then joined by a coupling 80 to form an endless belt. It is known to provide a coupling in which first and second half shells 82,84 are connected to one another by an adjustable fastener or adjustable fasteners 86 to secure the ends of the belt together between the opposing first and second half shells 82,84. The inner half shell 84 is shaped to resemble the lands 76 so as to ensure suitable engagement by the drive sprockets. Couplings of such kinds are known from EP3078880 (Arnold Jaeger GmbH) and U.S. Pat. No. 1,045,514 (Deere & Company).

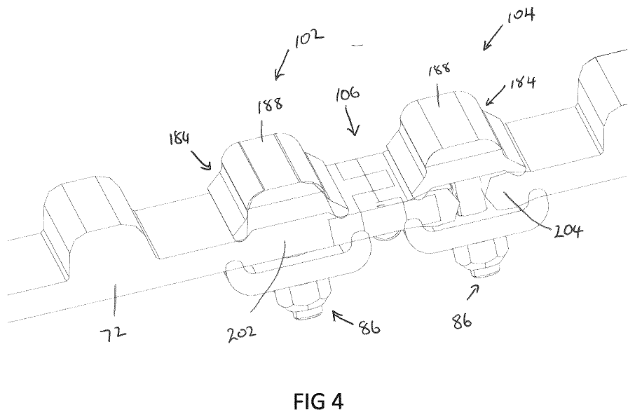

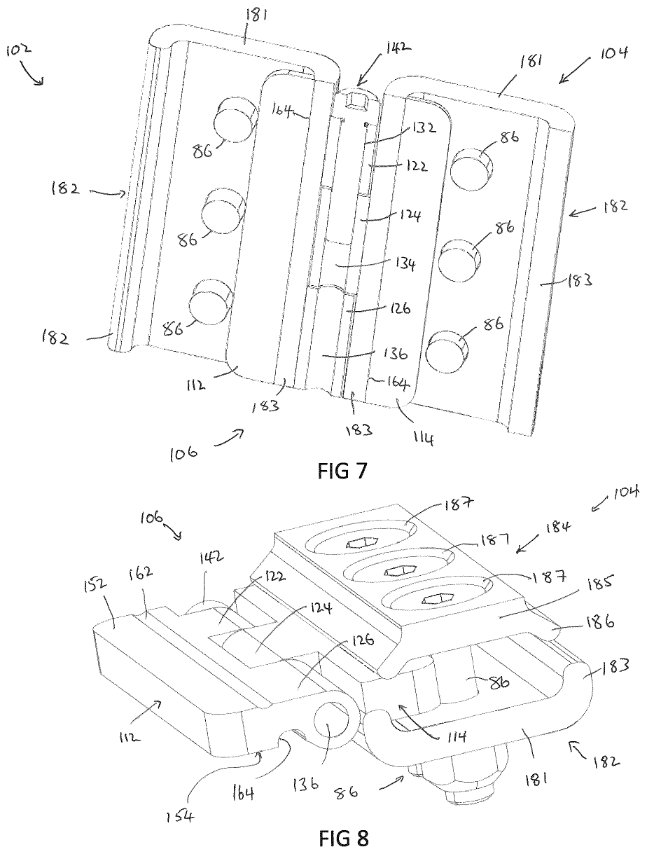

As shown most clearly in FIGS. 4 to 8, a first embodiment of a coupler for use with a coupling arrangement in accordance with the invention comprises separate first and second coupling elements 102,104 for the respective first and second ends 202,204 of the belt web 72 and a connecting element 106 for connecting the first and second coupling elements 102,104 to one another.

Each of the first and second coupling elements 102,104 are identical. The first coupling element 102 will be described in more detail, it being understood that the structure of the second coupling element 104 replicates the structure of the first coupling element 102, with like features being used to indicate like features in the Figures.

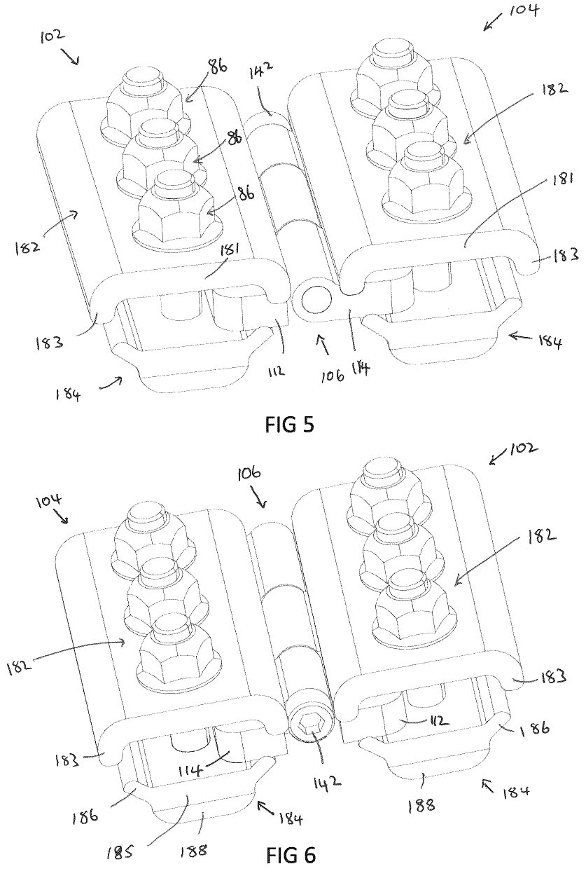

The first coupling element 102 comprises a clamping structure comprising an upper element 182 and a lower element 184 (as viewed in FIGS. 5 and 6). In practice, it will be understood that, once forming part of the completed belt located within the feederhouse, as the belt rotates within the feederhouse these orientations will change. In the following, references to “upper”, “lower”, “downward” and “upward” are intended to be understood with the coupler in the orientation shown in FIGS. 5 and 6).

The upper element 182 is generally C shaped having a generally planar central portion 181 terminating along first and second opposite edges with downwardly directed flanges 183. Free ends of these flanges 183 are rounded. The generally planar central portion 181 is provided with a plurality of through bores located along a centre line of the generally planar central portion 181 between the downwardly directed flanges 183. The through bores are of constant diameter. In the illustrated embodiment three such through bores or openings are provided.

The lower element 184 comprises a first part having a generally planar central portion 185 terminating along first and second opposite edges with flanges 186 angled upwards way from the generally planar central portion 185. The generally planar central portion 185 is provided with a plurality of openings located along a centre line of the generally planar central portion 185 between the upwardly angled flanges 186. Each opening comprises a through bore having a tapered portion 187. In the illustrated embodiment three such openings are provided.

In use a plurality of headed threaded fasteners 86 are arranged in the through bores of the upper element 182 and the lower element 184. The plurality of headed threaded fasteners 86 are adapted to draw together the upper element 182 and the first part of the lower element 184 by tightening of the fasteners 86. In the illustrated embodiment, the fasteners 86 each comprise a headed bolt, the head having a tapered end within which is provided with a hexagonal recess for engagement with a hex key and a matching nut. The tapered portion of each lower element first part through bore is adapted to receive the tapered head of a bolt such that the tapered bolt head is, in use, seated within the tapered portion 187 of an upper element through bore.

The lower element 184 further comprises a second part 188 for attachment to the first part as a cap or cover to shield the hexagonal recesses of the fasteners. The second part 188 may be secured to the first part in any suitable manner. The geometry of the first and second parts of the lower element 184 is such that it provides a surface for abutment by a sprocket pin as the belt is being driven.

The lower element 184 is shaped to resemble the lands 76 of the belt so as to ensure suitable engagement by the drive sprockets as the belt 72 is driven. In short, the lower element 184 should function as a fake belt step, where the separation between the lower elements 184 of the first and second coupling elements 102,104 provided by the connecting element corresponds to the spacing of the lands 76.

The connecting element 106 is a hinged element having first and second hinge elements or leaves 112,114 each having an interconnecting portion for interleaving with the other. In the illustrated embodiment, three knuckles are provided to form the interconnecting portion, a central knuckle 124 on the first leaf 112 and two outer knuckles 122,126 on the second leaf 114. Other numbers of knuckles can be envisaged. Each knuckle 122,124, 126 is provided with a through bore 132,134,136, preferably in each case a threaded bore.

The first and second leaves 112,114 are secured together by a securing element, such as a threaded hinge pin 142, extending through at least two of the knuckles. The hinge pin has a central axis extending along a central axis of the connecting element 106. It will be understood that other means of securing the two hinge elements together may be used. References to “inner” and “outer” in relation to the elements of the connecting element 106 are in relation to this central axis.

Each of the first and second leaves 112,114 has an outer portion having a first surface 152 and a second surface 154. A first groove 162 extends across the first surface 152 parallel to the central axis of the connecting element. A second groove 164 extends across the second surface 154 parallel to the central axis of the connecting element 106. In the illustrated embodiment the first groove 162 is laterally offset from the second groove 164 with respect to the central axis of the connecting element 106. The second groove 164 extends to a greater depth in the second surface 154 than the first groove 162 extends to in the first surface 152.

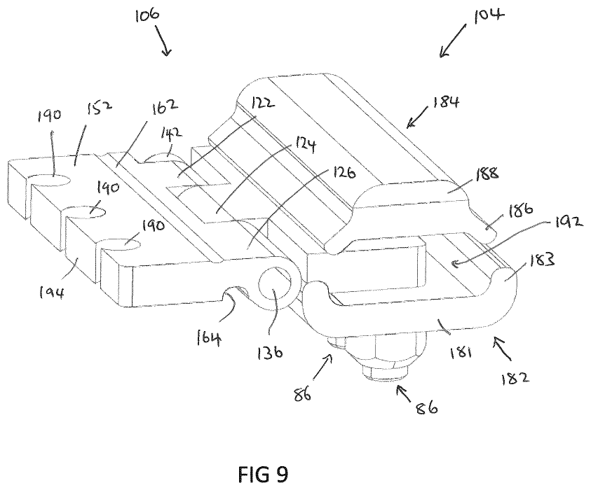

In use (and as best shown in FIG. 8) the second groove 164 is adapted to receive an inner downwardly directed flange 183 of the adjacent coupling element 102,104 and the first groove 162 is adapted to receive an upwardly angled flange 186 of the corresponding adjacent coupling element 102,104. It will be understood that an outer downwardly directed flange 183 and an outer upwardly angled flange 186 are adapted to receive an end of the elongate belt web 72, and retain these ends within the coupler during use.

In a second embodiment, shown in FIG. 9, a modified connecting element 106 of a coupler for use with a coupling arrangement in accordance with the invention is shown. Corresponding parts have been given corresponding reference numbers. The coupler comprises separate first and second coupling elements 102,104 for the respective first and second ends 202,204 of the belt web 72 and a connecting element 106 for connecting the first and second coupling elements 102,104 to one another. The first and second coupling elements 102,104 of this embodiment correspond to those of the first embodiment and are not described further.

The connecting element 106 of this embodiment, is broadly similar to that of the first embodiment, save that each leaf 112,114 extends beyond an inner portion of the adjacent coupling element 102,104. A plurality of openings 190 have been provided extending through each leaf 112,114. The plurality of openings 190 are located along a line extending parallel to the central axis of the connecting element 106.

In the illustrated embodiment these openings take the form of keyhole recesses provided in an outer edge of each leaf 112,114. The plurality of openings 190 allow passage of the threaded headed fasteners 86 through the respective leaf 112,114. It can be seen from FIG. 9 that as each opening 190 is part circular, with a diameter parallel to the central axis of the connecting element 106 set back from an outer edge of the respective leaf 112,114 through which the opening 190 extends, each opening 190 provides an additional region by which the connecting element 106 is secured to an adjacent coupling element 102,104.

In the illustrated embodiment, a gap 192 is provided between an outer face 194 of each leaf 112,114, and the upper and lower elements 182,184 of the coupling elements 104 for receiving an end of the elongate belt web 72, and retaining the ends within the coupler during use.

In use, once one belt 72 becomes worn such that the belt 72 loses tension, the coupling arrangement with the connection element 106 may be removed from the ends of the relevant belt webbing and the ends of the belt webbing reconnected using just one of the first or second first and second coupling elements 102, 104. In this way a suitable tension in a belt 72 may be restored without the need to dispose of the entire set of feederhouse belts.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of combine harvesters and component parts therefore and which may be used instead of or in addition to features already described herein.

What is claimed is:

1. A feederhouse belt and coupling arrangement for a feederhouse feed conveyor of an agricultural harvester is disclosed, the arrangement comprising:
an elongate belt comprising an elongate web with a first free end and a second free end, wherein the first end and the second end are thicker than the elongate web; and
a coupler having:
a connecting element, wherein the connecting element comprises first and second hinge elements, each hinge element having an interconnecting portion for interleaving with an adjacent hinge element and an outer portion having a free end and a securing element adapted to secure the first and second hinge elements with respect to one another;
first and second coupling elements, each coupling element comprising an upper element and a lower element, an outer edge of each upper element and an outer edge of each lower element having flanges adapted to received and retain a respective free end of the elongate belt therebetween, an inner edge of each upper element and an inner edge of each lower element having flanges adapted to received and retain the free end of the outer connecting portion of the connection element; and
at least one fastener adapted to draw the first and second coupling elements together.

2. A feederhouse belt and coupling arrangement according to claim 1, in which the first and second hinge elements are provided with grooves on a first surface adapted to receive the flanges of the first and second lower coupling elements.

3. A feederhouse belt and coupling arrangement according to claim 1, in which the first and second hinge elements are provided with grooves on a second surface adapted to receive the flanges of the first and second upper coupling elements.

4. A feederhouse belt and coupling arrangement according to claim 1, in which the securing element comprises a threaded locking pin.

5. A feederhouse belt and coupling arrangement according to claim 1, in which for each fastener adapted to draw the first and second coupling elements together, an outer portion of the respective hinge element is provided with an opening through which the fastener adapted to draw the first and second coupling elements together extends.

6. A feederhouse belt and coupling arrangement according to claim 5, in which each opening is part circular in section, with a diameter extending parallel to a central axis of the connecting element being set back from an outer edge of the outer portion of the hinge elements though which it extends.

7. A feederhouse comprising a plurality of feederhouse belts, including at least one belt and coupling arrangement according to claim 1, a drive arrangement for the feederhouse belts and a plurality of slats fixed to and between adjacent feederhouse belts, each of the slats extending laterally between a pair of feederhouse belts.

8. A combine harvester comprising a crop cutting head; a feederhouse according to claim 7; a threshing system; a separating system; and a grain cleaning system for receiving the cut and threshed crop material.
